(19) United States
(12) Patent Application Publication
(10) Pub. No.: US 2011/0299209 A1
(43) Pub. Date: Dec. 8, 2011

(54) BATTERY PROTECTION MODULE

(76) Inventors: Osamu Tajima, Tokyo (JP); Yoshinori Ishizaki, Tokyo (JP)

(21) Appl. No.: 13/150,518

(22) Filed: Jun. 1, 2011

(30) Foreign Application Priority Data
Jun. 3, 2010 (JP) 2010-127993

(51) Int. Cl. H02H 5/04; H01H 69/00

(52) U.S. Cl. 361/104; 29/623

(57) ABSTRACT

A battery protection module has a battery protection IC that is formed on a substrate, switching elements that are formed on the substrate and controlled by the battery protection IC, battery connecting terminals that are formed on the substrate, and a wire fuse that is disposed on a path on the substrate. In the path, the same current as the current flowing in the battery connecting terminals flows.

### CROSS REFERENCE TO RELATED APPLICATIONS

This application is entitled to and claims the benefit of Japanese Patent Application No.2010-127993, filed on Jun. 3, 2010, the disclosure of which, including the specification, drawings and abstract, is incorporated herein by reference in its entirety.

### TECHNICAL FIELD

The present invention relates to a battery protection module for protecting a battery from, for example, over-charge, over-discharge and abnormal current.

### BACKGROUND ART

Generally, for example, a battery pack of a portable device is provided with, in addition to a battery, a battery protection module to protect the battery from over-charge, over-discharge and abnormal current.

A secondary battery, especially a lithium ion battery, may be damaged if over-charge, over-discharge or abnormal current occurs. So, a protection module is provided to block a battery current to prevent the battery from being damaged, when over-charge, over-discharge or abnormal current is detected.

Patent literature 1 discloses such a battery protection module. Patent literature 1 discloses a configuration of a protection IC for detecting over-charge and over-discharge of a battery. Upon detecting these, the protection IC controls a switching transistor to turn off, thereby preventing the battery from being damaged by over-charge or over-discharge.

As a measure against abnormal current such as over-current, a current fuse is generally used. Patent literatures 2 and 3 disclose examples of the current fuse applied to a battery pack.

FIG. 1 shows a circuit diagram of a battery pack combining the battery protection module disclosed in patent literature 1 and the current fuse disclosed in patent literatures 2 and 3. In battery pack 10, battery protection module 11 has a protection IC and a switching transistor. Battery protection module 11 is connected to battery 12 via positive battery connecting terminal BH and negative battery connecting terminal BG. Also, positive terminal PH and negative terminal PG derive from battery protection module 11, and loads such as a charger (AC adaptor) and an electronic device are connected to these positive terminal

PH and negative terminal PG. In addition, a current fuse such as shown in patent literatures 2 and 3 is connected between battery protection module 11 and battery 12. With the configuration of FIG. 1, it is possible to protect the battery from over-charge, over-discharge and over-current.

### Patent Literature 1: Japanese Patent Application No. 2004-6524

### Patent Literature 2: Japanese Patent Application No. 2008-10501

### Patent Literature 3: Japanese Patent Application No. 2002-95157

### SUMMARY OF INVENTION

If the battery protection module disclosed in patent literature 1 and the current fuse disclosed in patent literatures 2 and 3 are combined, current fuse 13 is attached as an external component with respect to battery protection module 11 and battery 12, as shown in FIG. 2, and the battery pack therefore requires extra space of that proportion, which then makes it difficult to miniaturize the battery pack or increase the capacity of the battery.

Furthermore, when a current fuse needs to be provided as an external component, problems of making the configuration complex and incurring increased costs arise.

It is therefore an object of the present invention to provide a battery protection module that might improve the possibility of miniaturizing a battery pack and increasing its capacity.

According to one aspect of the present invention, a battery protection module to be mounted in a battery pack has: a substrate; a battery protection integrated circuit that is formed on the substrate; a switching element that is formed on the substrate and controlled by the battery protection integrated circuit; a battery connecting terminal that is formed on the substrate; and a wire fuse that is provided on a path on the circuit board where the same current as a current that flows in the battery connection terminals flows.

According to another aspect of the present invention, a method of manufacturing a battery protection module includes the steps of: forming a predetermined pattern of wiring on a substrate; and wire-bonding a circuit component and a wire fuse in predetermined locations in the wiring.

According to the present invention, a current fuse (wire fuse) is incorporated inside a battery protection module, so that it is possible to miniaturize a battery and increase its capacity. Also, a wire fuse can be formed in the same step as the step of wire-bonding circuit components, so that the manufacturing is easy.

### BRIEF DESCRIPTION OF THE DRAWINGS

FIG. 1 is a circuit diagram showing a conventional circuit combining a battery protection module and a current fuse;

FIG. 2 shows a layout of a conventional battery pack;

FIG. 3 is a wiring diagram showing a configuration of a battery protection module according to an embodiment;

FIG. 4 is a side view of a wire fuse;

FIG. 5 shows melting characteristics of a wire fuse when the number of wires is changed;

FIG. 6 shows a layout of components and terminals on a surface of a circuit board; and

FIGS. 7A and 7B show relationships between a wiring pattern on a circuit board, and components and terminals, where FIG. 7A shows the front surface side of a circuit board and FIG. 7B shows the back surface side of a circuit board.

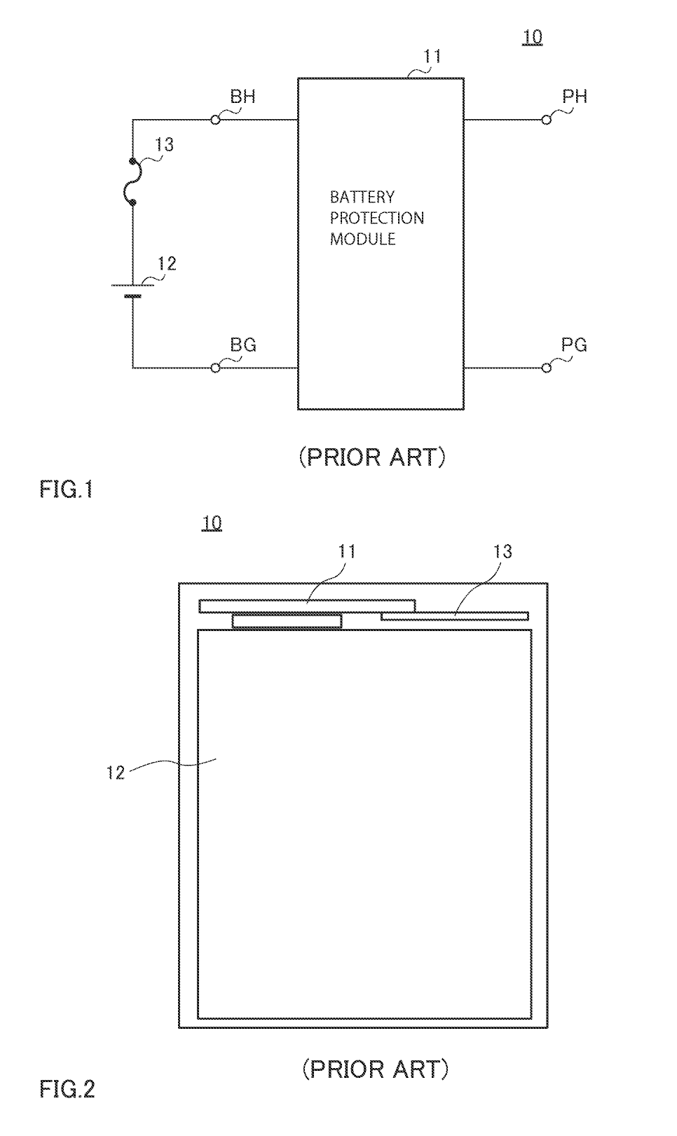

### DETAILED DESCRIPTION OF PREFERRED EMBODIMENTS

Now, embodiments of the present invention will be described in detail with reference to the accompanying drawings.

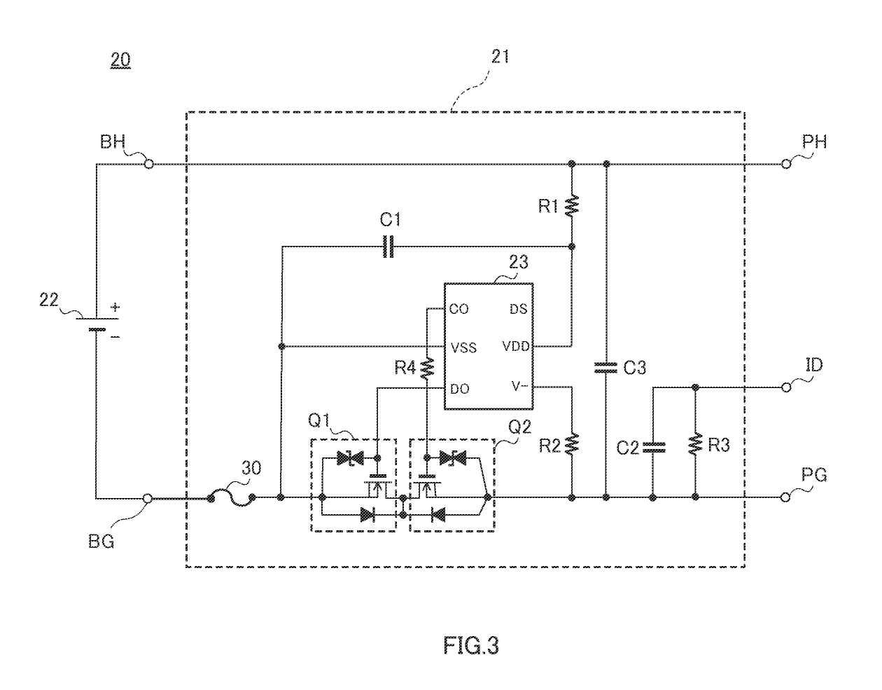

FIG. 3 shows a configuration of a battery protection module according to the present embodiment. In FIG. 3, “20” designates an overall configuration of a battery pack. Battery pack 20 is provided with battery protection module 21.

Battery protection module 21 is connected with battery 22 via positive battery connecting terminal BH and negative battery connecting terminal BG. Also, positive terminal PH and negative terminal PG derive from battery protection module 21, and loads such as a charger and an electronic device are connected to these positive terminal PH and negative terminal PG.

Battery protection module 21 has protection IC 23 and switching transistors (that is, transistor Q1 which functions as a discharge control switch and transistor Q2 which functions as a charge control switch).

In addition, battery protection module 21 has wire fuse 30. In other words, wire fuse 30 is incorporated in battery protection module 21. With the present embodiment, wire fuse 30 is provided between discharge control transistor Q1 and negative battery connecting terminal BG. To be more specific, wire fuse 30 is formed by wire-bonding a gold wire between the source of discharge control transistor Q1 and negative battery connecting terminal BG. Besides gold, aluminum, copper, and so on, may be used as the material of wire fuse 30.

With the present embodiment, transistors Q1 and Q2 are attached to the substrate by wire-bonding. Wire fuse 30 can be formed in the same step as the step of wire-bonding these transistors Q1 and Q2 onto the substrate, so that it is not necessary to introduce an additional step for making a fuse. Wire fuse 30 can therefore be formed easily.

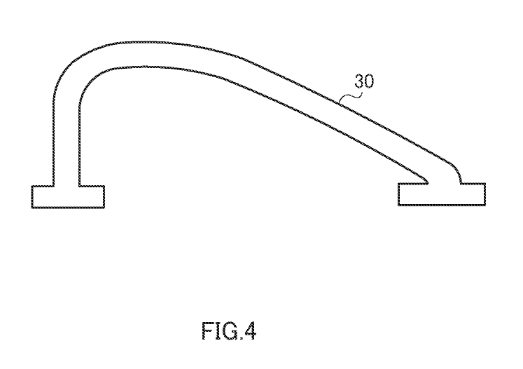

FIG. 4 shows the shape of wire fuse 30. FIG. 4 is a side view of wire fuse 30. Wire fuse 30 is designed in the same shape as the shape of other wire-bonded components (such as transistors Q1 and Q2).

Note that the number and length of wires to constitute wire fuse 30 are determined based on the over-current that needs to be blocked. The number of wires to constitute wire fuse 30 refers to the number of wires to be connected in parallel. Wire fuse 30 is more prone to melt at lower current and in shorter time when a smaller number of wires are connected in parallel. Also, when length of wires is longer, wire fuse 30 is more prone to melt at smaller current and in shorter time. The number and length of wires to constitute wire fuse 30 are set taking these into account.

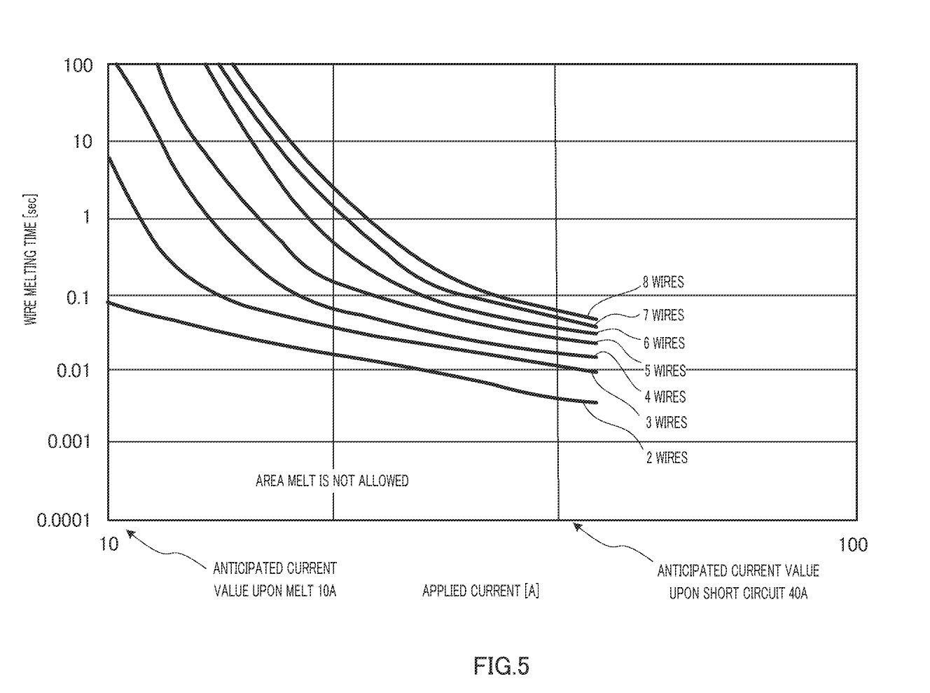

FIG. 5 shows melting characteristics of wire fuse 30 when the number of wires is changed. FIG. 5 shows an example case where the length of one wire of fuse 30 is 0.5 [mm].

Here, further as for the characteristics of wire fuse 30, wire fuse 30 is required to melt when, for example, a current of 10 [A] or higher is applied 10 [sec] or longer. In the example of FIG. 5, this requirement is fulfilled when two or three wires are provided. Consequently, the number of wires to constitute wire fuse 30 is set to two or three.

It is preferable to make the number of wires to constitute wire fuse 30 less than the number of other components wire-bonded onto the substrate. This makes the current that flows in the wires of wire fuse 30 always greater than the current that flows in other wires, so that, when over-current occurs, the wires of wire fuse 30 melt before other wires melt. By this means, when the wires melt, wire fuse 30 has only to be reformed, and this makes possible easy maintenance.

Incidentally, when a current of 40 [A] or greater is applied (current anticipated to occur upon a short circuit), battery protection module 21 blocks the current by means of protection IC 23 and transistors Q1 and Q2. In other words, large current such as one that occurs upon a short circuit is blocked by protection IC 23 and transistors Q1 and Q2. Also, if current occurs that is smaller than large current such as one upon a short circuit and that is greater than the rated current for over a certain period of time, wire fuse 30 blocks this current.

Next, parts in battery protection module 21 other than wire fuse 30 will be described.

Transistors Q1 and Q2 are connected in series between negative battery connecting terminal BG and negative terminal PG. Transistors Q1 and Q2 are each formed with a field effect transistor. Transistor Q1 operates as a discharge control switch, and transistor Q2 operates as a charge control switch.

Protection IC 23 has a VDD terminal, a VSS terminal, a DO terminal, a CO terminal, a V-terminal, and a DS terminal. The VDD terminal is connected to positive battery connecting terminal BH and positive terminal PH via resistor R1. The VSS terminal is connected to negative battery connecting terminal BG via wire fuse 30. Capacitor C1 is connected between the VDD terminal and the VSS terminal. The DO terminal is connected to the gate of transistor Q1. The V-terminal is connected to ground terminal PG via resistor R2. The CO terminal is connected to the gate of transistor Q2 via resistor R4.

Between identification terminal ID and negative terminal PG, resistor R3 and capacitor C2 are connected in parallel. Also, between positive terminal PH and ground terminal PG, capacitor C3 is connected. By this means, battery protection module 21 is able to identify the type or kind of a load or charger to be connected to identification terminal ID, and, based on what type or kind is detected here, the current blocking operation is controlled.

An over-discharge protection function and over-charge protection function are the major functions of protection IC 23. In actuality, protection IC 23 has an over-discharge control circuit (not shown) that makes possible the over-discharge protection function, and an over-charge control circuit (not shown) that makes possible the over-charge protection function.

Assume that a load is connected between positive terminal PH and negative terminal PG. Over-discharge detection threshold voltage Vth(od) is set in the over-discharge control circuit. That is to say, the over-discharge control circuit compares the voltage of battery 22 and over-discharge detection threshold voltage Vth(od), determines that over-discharge has occurred if the battery voltage falls below over-discharge detection threshold voltage Vth(od), and outputs a logical low-level over-discharge detection signal. When this over-discharge detection signal is supplied to the gate of transistor Q1, transistor Q1 is turned off.

Next, assume that a charger (which will be described later) is connected between positive terminal PH and negative terminal PG. When the battery voltage becomes greater than the over-discharge recovery voltage (Vth(od)+Vhy(od)) given by adding over-discharge hysteresis voltage Vhy(od) to over-discharge detection threshold voltage Vth(od), a logical high level over-discharge protection cancellation signal is output. When this over-discharge protection cancellation signal is supplied to the gate of transistor Q1, transistor Q1 is turned on.

Meanwhile, over-charge detection threshold voltage Vth(oc) is set in the overcharge control circuit. That is to say, the over-charge control circuit compares the voltage of battery 22 and over-charge detection threshold voltage Vth(oc), determines that over-charge has occurred if the battery voltage is greater than over-charge detection threshold voltage Vth(oc), and outputs an logical low-level over-charge detection signal. When this over-charge detection signal is supplied to the gate of transistor Q2, transistor Q2 is turned off.

Once again, assume that a load is connected between positive terminal PH and negative terminal PG. When the battery voltage becomes lower than the over-charge recovery voltage (Vth(oc)+Vhy(oc)) given by subtracting over-charge hysteresis voltage Vhy(oc) from over-charge detection threshold voltage Vth(oc), the over-charge control circuit outputs a logical high level over-charge protection cancellation signal. When this over-charge protection cancellation signal is supplied to the gate of transistor Q2, transistor Q2 is turned on.

Here, as shown in FIG. 3, transistor Q1 has a parasitic diode and is connected such that its forward direction matches the charge direction of battery 22. Consequently, even when transistor Q1 is placed in an off state, charging is possible by means of that parasitic diode. Similarly, transistor Q2 also has a parasitic diode and is connected such that its forward direction matches the charge direction of battery 22. Consequently, even when transistor Q2 is placed in an off state, charging is possible by means of that parasitic diode.

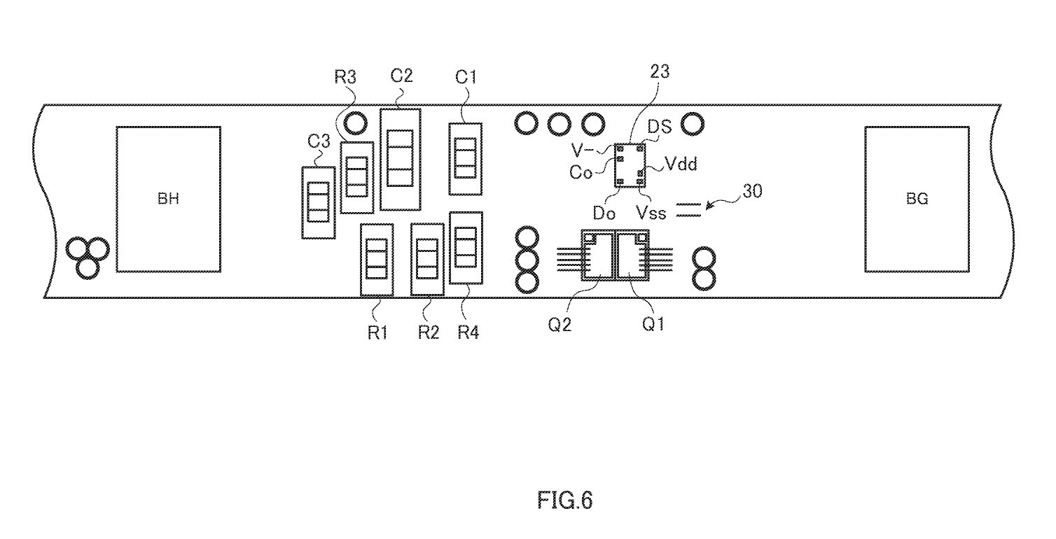

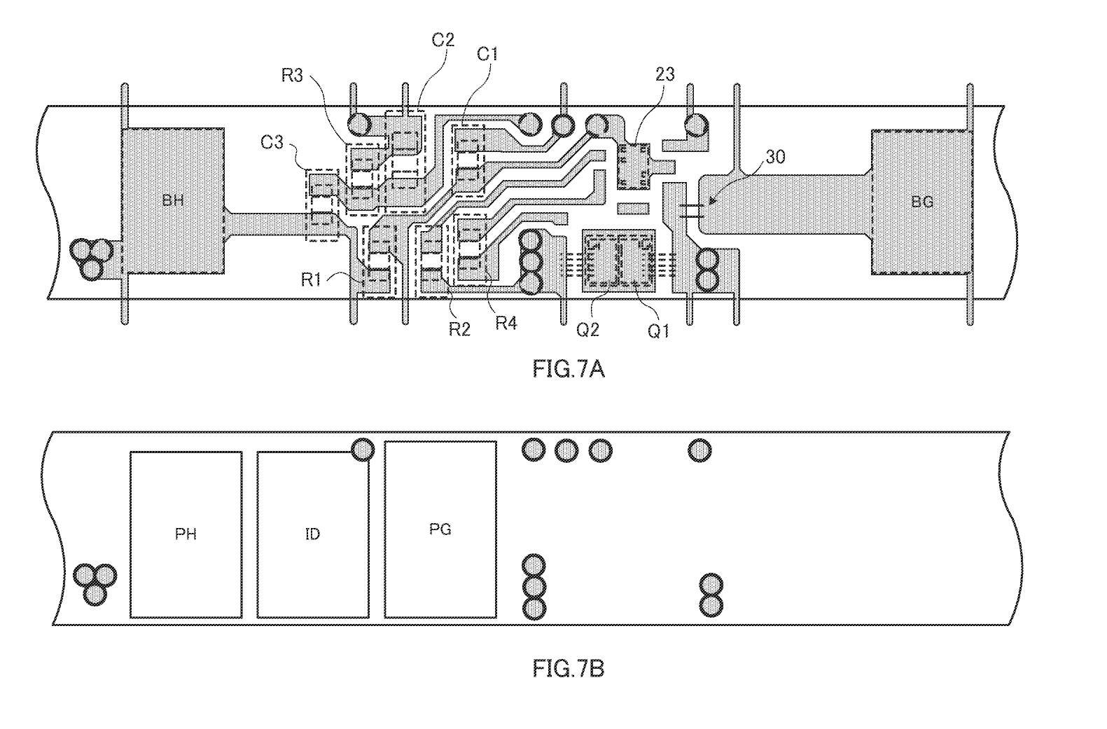

FIG. 6 and FIGS. 7A and 7B show a layout on the circuit board of battery protection module 21. FIG. 6 shows a layout of components (protection IC 23, transistors Q1 and Q2, wire fuse 30, resistors R1 to R4, and capacitors C1 to C3) and terminals (positive battery connecting terminal BH and negative battery connecting terminal BG) on the surface of a circuit board. FIGS. 7A and 7B show a circuit board wiring pattern and the relationships between the components and terminals, where FIG. 7A shows the front surface side of a circuit board and FIG. 7B shows the back surface side of the circuit board. Solid line circles shown in FIG. 6 and FIGS. 7A and 7B represent through-holes. The circuit board is a rectangular shape, 5 to 6 mm long vertically and 30 mm long horizontally.

As shown in FIG. 7A, wire fuse 30 is provided between discharge control transistor Q1 and negative battery connecting terminal BG. FIG. 7A shows an example case where wire fuse 30 is formed with two wires.

As described above, with the present embodiment, wire fuse 30 is provided on the same substrate (that is, the same module) with battery protection IC 23 and transistors Q1 and Q2, so that, compared to a case where a case is attached externally, it is possible to miniaturize a battery pack and increase its capacity. Also, wire fuse 30 can be formed in the same step as the step of wire-bonding circuit components, so that the manufacturing is easy. Furthermore, convenience is improved because the melting characteristics are controlled by simple operations of changing the number and length of wires.

Although cases have been described with the above embodiments where wire fuse 30 is provided between discharge control transistor Q1 and negative battery connecting terminal BG, the present invention is by no means limited to this. For example, it is equally possible to provide wire fuse 30 between positive battery connecting terminal BH and positive terminal PH. An essential point is to provide wire fuse 30 on a path on a circuit board where the same current as the current to flow in battery connecting terminals BG and BH flows.

The battery protection module of the present invention is suitable for use for a battery pack for a portable electronic device such as a mobile telephone and digital camera.

What is claimed is:

1. A battery protection module to be mounted in a battery pack, comprising:
a substrate;
a switching element formed on the substrate;
a battery protection integrated circuit formed on the substrate for controlling the switching element;
a battery connecting terminal formed on the substrate for flowing a specific current therein; and
a wire fuse disposed on a path where the specific current flows.

2. The battery protection module according to claim 1, wherein at least one of the battery protection integrated circuit and the switching element is wire-bonded onto the substrate.

3. The battery protection module according to claim 2, wherein the wire fuse is formed of one single wire or a plurality of wires connected in parallel in a number less than that of wires of the battery protection integrated circuit or the switching element.

4. A method of manufacturing a battery protection module, comprising the steps of:
forming a wiring with a predetermined pattern on a substrate; and
wire-bonding a circuit component and a wire fuse on the wiring at a predetermined location.
